(19) United States
(12) Patent Application Publication
(10) Pub. No.: US 2013/0145999 A1
(43) Pub. Date: Jun. 13, 2013

(54) A SYSTEM TO PRODUCE HYDROGEN GAS FUEL

(71) Applicant: UNIVERSITI MALAYSIA PAHANG, Pahang Darul Makmur (MY)

(72) Inventors: Zularisam AB WAHID, Pahang Darul Makmur (MY); Abdul Syukor ABD RAZAK, Pahang Darul Makmur (MY); Mimi Sakinah ABDUL MUNAIM, Pahang Darul Makmur (MY)

(73) Assignee: UNIVERSITI MALAYSIA PAHANG, Pahang Darul Makmur (MY)

(21) Appl. No.: 13/759,804

(22) Filed: Feb. 5, 2013

Related U.S. Application Data
(62) Division of application No. 12/765,117, filed on Apr. 22, 2010.

(30) Foreign Application Priority Data
Feb. 22, 2010 (MY) PI 2010000766

(51) Int. Cl. F02B 43/10

(52) U.S. Cl. CPC F02B 43/10
USPC 123/3

(57) ABSTRACT

A system for producing hydrogen gas fuel from water source or waste water source or a combination thereof to supplement an internal combustion engine. The system includes at least a hydrogen fuel electrolyzer, at least an electrical power storage means, at least a air intake chamber in the engine, at least an ignition switch, and at least a relay.

### CROSS-REFERENCE TO RELATED APPLICATIONS

This application is a Divisional of co-pending application Ser. No. 12/765,117, filed on Apr. 22, 2010, for which priority is claimed under 35 U.S.C. §120; and this application claims priority of Application No. PI 2010000766, filed in Malaysia on Feb. 22, 2010 under 35 U.S.C. §119,the entire contents of all of which are hereby incorporated by reference.

### FIELD OF INVENTION

The present invention relates to a system to produce hydrogen gas fuel.

### BACKGROUND OF INVENTION

Fossil fuel such as diesel and petrol that are drawn from finite resources are non renewable and is becoming more expensive and unaffordable besides polluting the environment. There has been a constant increase in oil price due to depletion of fossil fuel resources and increase in energy demand (due to intensive industrialization, population and automotive activities). Furthermore fossil fuel burns incompletely thus contributes to emission of greenhouse gasses, global warming and other detrimental environmental problems.

Therefore a cheaper, cleaner, sustainable and environmental friendly fuel source is urgently needed.

### SUMMARY OF INVENTION

Accordingly, the present invention provides a system to produce hydrogen gas fuel from water source or waste water source or a combination thereof, wherein the system includes at least an electrical power supplying means, at least an electrical power storage means, at least a pumping means, at least a hydrogen fuel electrolyzer, at least a distribution pipeline, at least a flash back retarder and at least a generator to produce electricity characterized in that the electrolyzer includes at least a sewage level controller, at least a anode terminal, at least a cathode terminal, at least a sewage level, at least a safety valve, at least a pressure gauge, at least a temperature gauge, at least a gas exit valve, at least a sludge drain out valve and at least a outlet valve.

Further provided is a system for producing hydrogen gas fuel from water source or waste water source or a combination thereof to supplement an internal combustion engine wherein the system includes at least a hydrogen fuel electrolyzer, at least an electrical power storage means, at least a air intake chamber in the engine, at least an ignition switch and at least a relay.

Also provided is an electrolyzer for producing hydrogen gas fuel from water source or waste water source or a combination thereof, the electrolyzer includes at least a sewage level controller, at least an anode terminal, at least a cathode terminal, at least a sewage level, at least a safety valve, at least a pressure gauge, at least a temperature gauge, at least a gas exit valve, at least a sludge drain out valve and at least a outlet valve.

Last but not least, the present invention also provides a process for producing hydrogen gas fuel from water source or waste water source or a combination thereof, wherein the process includes the steps of generating electrical power by at least an electrical power supplying means or from a means to supply electrical power, storing the electrical power in at least an electrical power storage means, supplying electricity for pumping the from the water source or waste water source or a combination thereof to a hydrogen fuel electrolyzer while level of the water source or waste water source or a combination thereof within the electrolyzer and pump are controlled and electrolyzing the water source or waste water source or a combination thereof in the presence of a catalyst solution such as potassium hydroxide, sodium hydroxide or ethanoic acid, having 2% to 6% v/v% (or any other unit that is appropriate) for a period of at least 0.03 hours to 60 hours to produce hydrogen gas fuel.

The present invention consists of several features and a combination of parts hereinafter fully described and illustrated in the accompanying description and drawings, it being understood that various changes in the details may be made without departing from the scope of the invention or sacrificing any of the advantages of the present invention.

### BRIEF DESCRIPTION OF DRAWINGS

FIG. 1 illustrates a schematic view of a system to produce hydrogen gas fuel installed to a domestic house according to the preferred embodiments of the invention;

FIG. 2 illustrates a detailed view the system;

FIG. 3 illustrates a detailed schematic view of the system.

### DETAILED DESCRIPTION OF THE PREFERRED EMBODIMENT

The present invention relates to a system to produce hydrogen gas fuel. Hereinafter, this specification will describe the present invention according to preferred embodiment. However, it is to be understood that limiting the description to the preferred embodiment is merely to facilitate discussion of the present invention and it is envisioned that those skilled in the art may devise various modifications and equivalents without departing from the scope of the appended claims.

Hydrogen is the ideal alternative for future fuel as it burns completely, contains high flammability and produces no greenhouse gas but water. Naturally hydrogen presents in the form of water molecule with combination of 2 hydrogen atoms and 1 oxygen atom, therefore hydrogen gas must be generated by mean of physical or chemical process such as electrolysis.

Conventionally hydrogen is electrolyzed by high energy input that is derived from hydrocarbon fuel therefore it becomes inefficient and uneconomic. To overcome this issue, the present invention produces hydrogen using higher technological efficiency and therefore will significantly reduce our dependability on fossil fuel, preserve the environmental quality and as well as able to push forward the green technology to greater height.

Essentially, the present invention generates hydrogen from water sources such as rain water, river water, seawater, tapwater, sewage and leachate by using solar energy and wind turbine assembly as energy providers.

This invention primarily employed photovoltaic collectors which generates electricity and stores the obtained electrical power in batteries. However, it is envisaged that other electrical power supplying means and other electrical power storage means can be used instead of the photovoltaic collector and batteries, respectively. The batteries which act as the energy storing devices supplies relatively inexpensive electrical energy for the system to generate hydrogen gas fuel through enhanced electrolysis process.

In general there are numerous processes that can be employed to electrolyze and separate a water molecule into its elemental hydrogen and oxygen elements such as the electrolysis process. However the hydrogen and oxygen generated through this conventional electrolysis are generally produced in inefficient manner and involved with problems such as requirement of high electrical power (more than 500 watt), costly electrolytic cells, electrode cell tends to heat-up, the produced gas need to be immediately transferred to a pressurized storage, low hydrogen/oxygen gas production, boiling water and electrode cell forms gas bubbles that acts as electrical insulators that subsequently reduce the cell functionality. Thus, this newly innovative system has been designed and developed in order to overcome the above mentioned problems. The most inventive step in this invention is its ability to generate hydrogen gas fuel at lower voltage source (12 V), at ambient pressure (14.2 psi) and at a controllable amount of fuel gas in order to provide an optimal source of fuel. A relatively stable hydrogen gas production (0.6 LPM to 2.2 LPM) at a modest power input (12-180 watt) and in the range of 1 A to 15 A has been successfully generating hydrogen gas fuel through this enhanced electrolysis process.

The generated hydrogen gas could be used as potential fuel for fuelling incinerator, internal combustion engine, thermal electric power generation, furnaces, heaters and cooking stoves. In particular, little if any polluted toxic carbon dioxide and water vapour is the exhaust products from hydrogen fuel combustion.

Furthermore this invention is not only capable of producing hydrogen gas from water sources but also concurrently able to treat the wastewater such as sewage and leachate by increasing the wastewater's quality such as carbon oxygen demand (COD), suspended solids and biochemical oxygen demand (BOD₅).

Apart of that such as application for the internal combustion engine, the generated hydrogen gas could also act as supplement fuel in addition to hydrocarbon fuel, thus subsequently would save petrol consumption up to 35% and increase mileage.

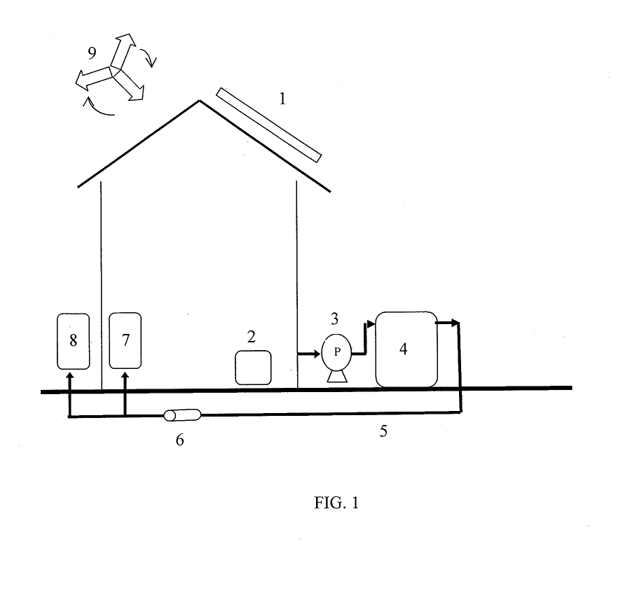

FIG. 1 illustrates a schematic view of the system (4) installed to a domestic house. Sewage is transferred from sewerage pipe to the system (4) by pump (3). Electrical power for pumping and supporting the system operation is supplied by batteries (2) that are charged by photovoltaic solar panel (1) and/or from other means to supply electrical power such as the wind turbine assembly (9).

The generated hydrogen gas is distributed through pipeline (5) to kitchen stove or cooker (7) and/or to power generator (8) that generates electricity from hydrogen gas. A flash back retarder (6) is installed as safety device that will hinder any flash back of hydrogen fuel to the system (4).

For the purpose of elucidation, as referring to FIG. 1, the system (4) is installed to a domestic house whereby the house's sewerage line provides the sewage to the system (4) by a mechanical pump (3). The system (4) electrolyzed the sewage through enhanced electrolysis process and produces the hydrogen gas fuel based on the demand. The produced hydrogen gas fuel is then distributed via pipeline (5) to cooker or stove in the house's kitchen (7). The hydrogen gas is also made available to electrical generator (8) should the owner want to generate electricity from hydrogen gas. A flash back retarder (6) is also installed in the pipeline (5) as a safety device.

The electrical power for the above operation is drawn from the photovoltaic collectors (1) or wind turbine (9) which stored the electricity in batteries (2). Other water or wastewater sources that are generated from household activities may also be used as water source for hydrogen gas fuel generation. In this particular case sewage sample is taken as a source of water for electrolysis since the system (4) may not only generate hydrogen gas fuel but also could treat and increase the sewage effluent quality.

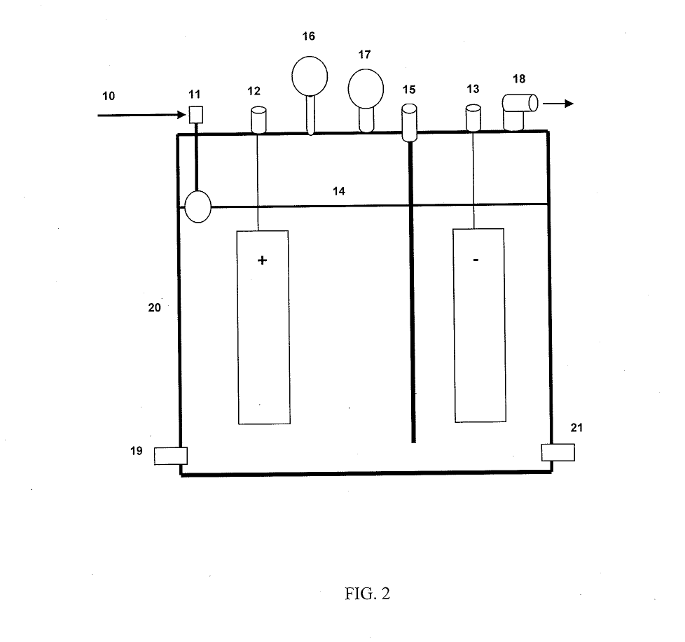

FIG. 2 illustrates a detailed view of another embodiment of a system (20) for producing hydrogen gas fuel which comprises sewage level controller (11), anode terminal (12), cathode terminal (13), sewage level (14), safety valve (15), pressure gauge (16), temperature gauge (17), gas exit valve (18), sludge drain out valve (19), the reactor (20) and outlet valve (21).

Referring to FIG. 2, in the present invention, the production process of hydrogen gas comprises the steps of subjecting the sewage into the system (20) from sewerage line (10). The volume of the system (20) can be scaled up or down depending on the requirement of applications.

The level of sewage (14) within the system (20) is controlled by a buoyant water level controller (11) which also controls the switch on/off of mechanical pump (3).

In particular, the reaction chamber comprises two electrodes of selected metals nested inside each other. The electrodes are anode (12) and cathode (13) terminals. The anode and cathode terminals are made from stainless steel 316, platinum or aluminium. A low voltage source (12 V to 14 V) which generates electric current (1 ampere to 15 amperes) that tunnels through the sewage or water sample between the tips of electrodes is constantly supplied upon requirement. The electrolysis process dissociates (break down) the nearby water molecules into hydrogen and oxygen atoms and the resulting hydrogen and oxygen gasses molecules cool and bubble up to the surface in the surrounding water where they are delivered to pipeline (5) through gas exit valve (18). A relatively stable hydrogen gas fuel production (0.6 LPM to 2.2 LPM) at a modest power input (12 watt to 180 watt) represents the most advantages offered by the system (20).

A pressure gauge (16) is installed in order to monitor and maintain the operating pressure to be around 14.2 psi to 25 psi. A temperature gauge (17) is installed so as to monitor the operating temperature so that the system's temperature is not exceeding 66° C. Safety valve (15) is installed to overcome the potential of back pressure due to inefficient distribution of hydrogen gas. The safety valve (15) is connected with submerged tubing under the sewage level (14).

The treated sewage can be discharged to storm water drain through outlet valve (21) before it goes to the public water way or river only after being electrolyzed for at least 3.0 hours. Furthermore the sludge of electrolyzed sewage can be drawn out from the system (20) through drain out valve (19) and can be further used as potential fertilizer.

As shown in FIG. 2, sewage is employed as the source of water. Operational condition and process were performed as mentioned in the detailed description section. The sewage has COD of 842 ppm, suspended solids measured as 917 ppm and BOD₅ of 324 ppm. Subsequently after 3.0 hours of electrolyzing the sewage at 0.8 LPM to 1.32 LPM hydrogen gas production rate the sewage was measured to have COD of 93 ppm, suspended solids of 77 ppm and BOD₅ of 39 ppm. This example showed that the present invention is not only capable of producing satisfactory hydrogen gas but also able to treat sewage effluent up to Standards B of regulations stipulated by the Malaysian Department of Environment (DOE).

Synthetic gas fuel from renewable source such as water is a solution to reduce oil consumption and carbon dioxide emissions without the need for modifications of automobile existing infrastructure. In conjunction, in a preferred embodiment of the present invention, there is provided a method incorporating the advantages of synthesized hydrogen gas fuel from any water sources combined with petrol combustion thus eventually resulting in automotive engine or car's engine oil that consumes lesser hydrocarbon and cleaner emission.

The use a catalyst solution such as such as potassium hydroxide, sodium hydroxide or ethanoic acid, having 2% to 6% v/v% (or any other unit that is appropriate) for a period of at least 0.03 hours to 60 hours enhances the electrolysis process.

Therefore it could generate a satisfactorily volume of hydrogen gas at lower electrical energy (lower than 180 watt) compared to conventional electrolysis which requires greater electrical energy (more than 500 watt) for the same amount of hydrogen volume. A range of 5% to 20% of catalyst solution is used during the enhanced electrolysis process.

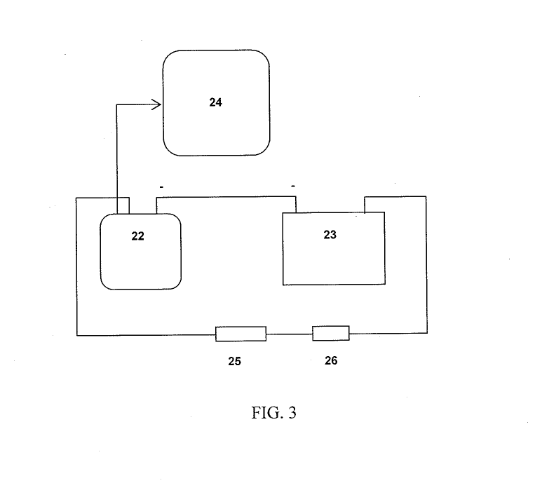

FIG. 3 illustrates a detailed schematic view of another embodiment of a hydrogen fuel electrolyzer (22) installed in a conventional combustion engine which comprises an automobile battery (23) such as a car battery, an automobile engine (24) such as a car engine, ignition switch (25) and relay (26). The electrolyzer (22) is connected to a battery (23) which supplies electrical power and controlled by the ignition switch (25) and relay (26) for safety purposes.

As referred to in FIG. 3, a hydrogen hybrid system which comprises the electrolyzer (22) has been developed to sustainably produce a clean renewable alternative fuel (oxyhydrogen=a mixture of hydrogen and oxygen gases) that is technologically derived from any water sources such as tap water or river water or rain water or lake water or wastewater. The electrolyzer (22) splits water molecules (H₂O) into hydrogen and oxygen gases through enhanced electrolyzing process to supplement an ordinary internal combustion engine (to the air-uptake chamber) (24) such as petrol and diesel which then will be ignited in the combustion chamber, subsequently save petrol consumption (up to 35%), increase fuel mileage, increase horse power (as hydrogen is 4 times more combustible than petrol fuel) and decreases hazardous emissions.

The most inventive step in this invention is its ability to generate a cost effective alternative fuel gas at a low voltage source (12 V), at ambient pressure (14.2 psi) and at a controllable amount of hydrogen fuel gas (on demand) which provides a considerable amount of heat or kinetic energy that enables vehicle to travel more economically (reduce the amount of petrol fuel required over a given distance). A relatively stable fuel gas production is expected (0.6 LPM to 2.2 LPM liters of oxy-hydrogen) at a modest power input (12 watt to 180 watt) which produces CO emission that is 20% lower than the conventional combustion engine, represent the most advantages offered by the system (22), which comprises reaction chamber two electrodes of selected metals nested inside each other.

It is noted that the quality of the electrolyzed wastewater particularly sewage can be improved during at least 3 hours of electrolysis process wherein it is observed that there is COD reduction up to 88%, suspended solids removal up to 91% and BOD₅ removal up to 87%.

1. A system for producing hydrogen gas fuel from water source or waste water source or a combination thereof to supplement an internal combustion engine wherein the system includes at least a hydrogen fuel electrolyzer, at least an electrical power storage means, at least a air intake chamber in the engine, at least an ignition switch and at least a relay.

2. The system as claimed in claim 1, wherein the electrical power storage means is an automobile battery.

3. The system as claimed in claim 1, wherein a voltage of 12 volt is derived from the battery to the electrolyzer to produce hydrogen gas fuel.

4. The system as claimed in claim 1, wherein electrical ampere of between 1 A to 15 A is applied in the system.

5. The system as claimed in claim 1, wherein the anode and cathode terminals are made from stainless steel 316, platinum or aluminium.

6. The system as claimed in claim 1, wherein generated hydrogen gas fuel is ignited along with petrol or diesel in the combustion chamber.
